(19) United States
(12) Patent Application Publication
(10) Pub. No.: US 2005/0240706 A1
(43) Pub. Date: Oct. 27, 2005

(54) Peripheral device control system

(75) Inventor: Chung-Hung Tsai, Jhubei City (TW)

Correspondence Address: Hoffman, Warnick & D'Alessandro LLC, Three E-Comm Square, Albany, NY, 12207, US

(73) Assignee: MEDIATEK INC., Hsin-Chu City (TW)

(21) Appl. No.: 11/111,510

(22) Filed: Apr. 21, 2005

(30) Foreign Application Priority Data
Apr. 23, 2004 (TW) 093111529

(51) Int. Cl. G06F 13/36

(52) U.S. Cl. 710/306

(57) ABSTRACT

A peripheral device control system comprises a processor, a first bus, and a bridge device. The processor comprises a set of control instructions. The first bus couples to the processor by the first bus protocol. The bridge device communicates with the first bus by the first bus protocol and communicates with the peripheral device by a second protocol, wherein the processor transmits a set of control instructions to the peripheral device through the first bus and the bridge device, so as to directly control the peripheral device to perform a specific function.

### BACKGROUND OF THE INVENTION

1. Field of the Invention

This present invention relates to a control system for controlling peripheral devices.

2. Description of the Prior Art

With the constant expansion in the functions of computer systems, various devices and methods are developed to organize and control computer peripheral devices. Conventionally, the computer system has a central processing unit (CPU) which is used for controlling every component and peripheral device in the computer system. The central processing unit is usually coupled to a bus, and it uses a predetermined frequency, commonly called the external frequency of the central processing unit, to transmit data to the bus or to communicate through signals with the bus. The data processing speed of each peripheral device, the data processing speed of the central processing unit, and the speed of the bus are often different from each other. The speed difference may be large. Therefore, the peripheral device slower in speed generally passes through the chipsets, such as the north and south bridge chipsets to couple to the bus.

The central processing unit generally does not directly control any specific or detailed operations of the peripheral devices. Most of the peripheral devices of the prior art have micro-controllers such as 8032 and Z80. When the central processing unit transmits an instruction to the peripheral devices, the micro-controller of the peripheral device receives this instruction; the micro-controller then controls each of the functional modules of the peripheral devices and performs the request of the instruction.

Because the peripheral devices cannot be directly controlled by the central processing unit of the prior art, and the peripheral devices must include the micro-controller for the CPU to control every function of the peripheral device and to enable peripheral devices to operate normally, the installation of the micro-controller must be considered during the design phase of the peripheral devices and their modules. This will cause an increase in the manufacturing cost.

### SUMMARY OF THE INVENTION

The present invention provides a control system, in which a processor can cooperate with a bridge device to directly control a peripheral device. Meanwhile, the present invention does not require a micro-controller equipped inside the peripheral device to receive the instruction from the processor, control the modules inside the peripheral device, and perform requested operations.

According to an embodiment, the control system comprises a processor, a first bus, and a bridge device. The processor comprises a set of controlling instructions. The set of controlling instructions are transmitted through the first bus to the bridge device by a first protocol. Moreover, the bridge device communicates with the processor by the first bus protocol of the first bus, and it communicates with the peripheral devices by a second bus protocol of a second bus. The control instructions transmitted from the processor pass through the first bus to the bridge device. The bridge device further transmits the set of control instructions and sends them through the second bus to peripheral devices. Thus, unlike conventionally through the micro-controller to control, the processor of the embodiment can directly control the peripheral devices to perform functions.

Compared to the conventional controlling systems, the control system of the embodiment directly controls the peripheral devices without the need of a microprocessor inside the peripheral device. Therefore, the manufacturing cost of the peripheral device could be lowered.

### BRIEF DESCRIPTION OF THE APPENDED DRAWINGS

FIG. 1 is the function block diagram of an embodiment of the control system.

FIG. 2 is a function block diagram of the bridge device of FIG. 1.

FIG. 3 is a clock pulse diagram of the embodiment of the control system.

FIG. 4 is the function block diagram of the peripheral device and the bridge device of FIG. 1.

FIG. 5 is a function block diagram of another embodiment of the control system.

### DETAILED DESCRIPTION OF THE INVENTION

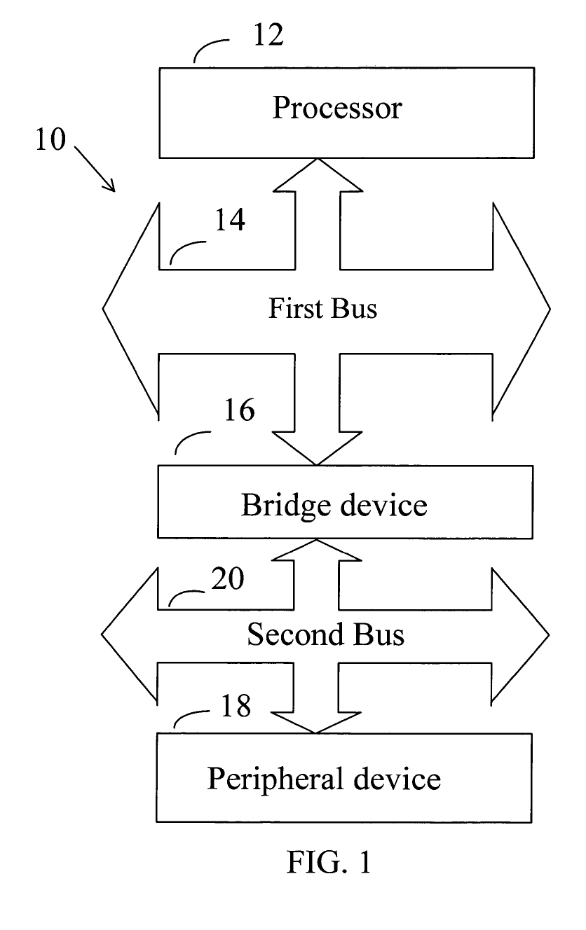

Referring to FIG. 1, FIG. 1 is the function block diagram of an embodiment of the control system of the present invention. The control system 10 comprises a processor 12, a first bus 14, and a bridge device 16. In this embodiment, the first bus 14 could be an Advanced Micro-controller Bus Architecture bus (AMBA); the AMBA bus is coupled between the processor 12 and the bridge device 16, and it transmits data or instructions to the bridge device 16 by a first bus protocol (for example, AMBA bus protocol). The bridge device 16 further couples to and transmits data to the peripheral device 18 through the second bus 20. The transmitted data may comprise a writing instruction or a reading instruction. The processor 12 could use these instructions contained in the transmitted data to directly control the peripheral device 18.

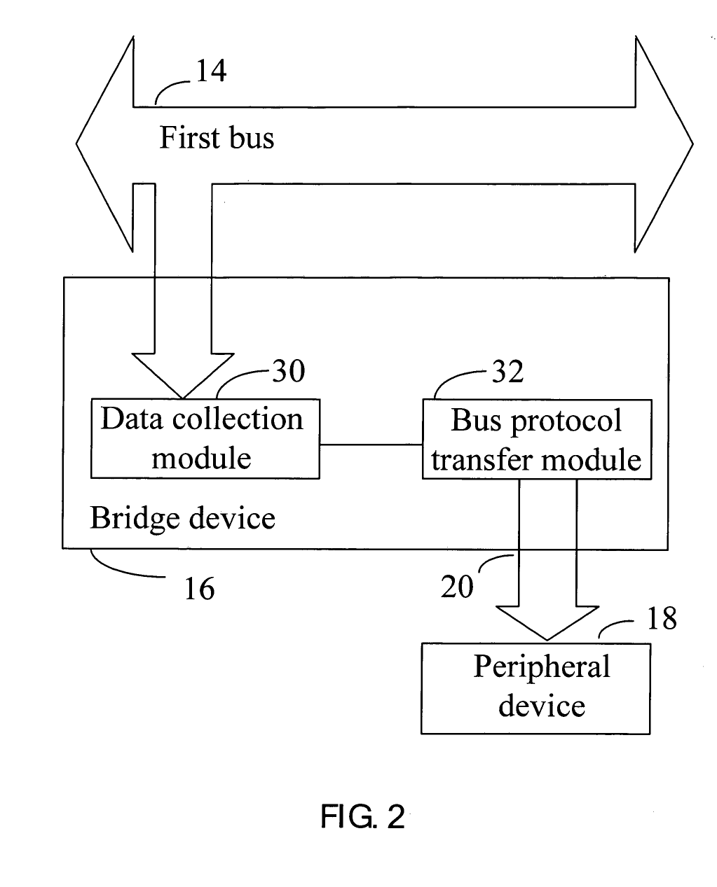

Referring to FIG. 2, FIG. 2 is a function block diagram of the bridge device 16 of FIG. 1. The bridge device 16 comprises a data collection module 30 and a bus protocol transfer module 32. The data collection module 30 couples to the first bus 14. The data collection module 30 determines and collects related and appropriate information according to the address signals of the data transmitted on the first bus 14. The bus protocol transfer module 32 is used to transfer the data collected by the data collection module 30 from the first bus protocol to the second bus protocol, so that the data or the instruction is in accordance with the format of the second bus protocol and to be transmitted from the second bus 20 to the peripheral device 18.

In the control system of this embodiment, the processor 12 can be a Reduced Instruction Set Computer Processor (RISC Processor), such as an ARM or MIPS processor. The processor 12 comprises an address space; the processor 12 sends a set of address signals within the address region to control the operation of the peripheral device. When the control system 10 requests the peripheral device 18 to perform an operation, the processor 12 would generate a set of control instructions that comprise a set of address signals located within the address region, and the set of control instructions would be transmitted by the first bus 14. Because the bridge device 16 couples to the first bus 14, when the data collection module 30 determines that the control instruction currently on the first bus 14 comprises a set of related address signals among them, the content of the set of control instructions is collected to the bus protocol transfer module 32. Later, the bus protocol transfer module 32 will store the content of the instructions temporarily. Next, the second protocol transfer the instructions that are then transmitted to the peripheral device 18, thus allowing the processor 12 to use the set of instructions to directly control the peripheral device 18.

It will be illustrated how the processor 12 utilizes the bridge device 16 to transfer signals of the first bus 14 into signals of the second bus 20 to control the peripheral device 18. In this embodiment, when the processor 12 wants to write data into the peripheral device 18, the processor 12 would issue a set of control instructions, so as to control the peripheral device 18 later on. The set of control instructions includes an address signal, a write signal, a data signal, and a data ready signal. The processor 12 transmits the set of control instructions, which follows the AMBA bus protocol, through the first bus 14 (AMBA bus) to the bridge device 16. When the bridge device receives the set of control instructions, it would perform the signal protocol transfer, so as to further transmit the control instructions to the peripheral device 18.

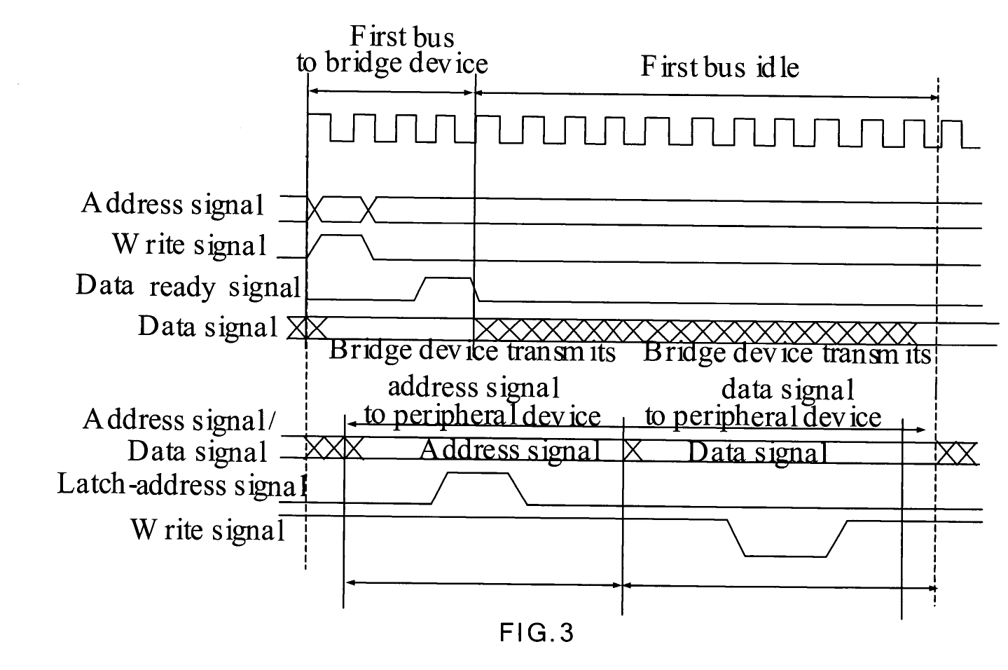

In the embodiment shown in FIG. 3, the processor 12 first transmits an address signal and a write signal to the bridge device 16 by the first bus 14, and a data signal is transmitted afterwards. When the transmission of data signal is finished, a data ready signal is transmitted to the bridge device 16. These signals are illustrated in the upper half of FIG. 3. After the first bus 14 finishes the above-mentioned transmission of signals, it will return to the idle state. The processor 12 can utilize the first bus 14 to communicate with other devices at this moment, in order to maximize the efficiency of the processor 12. The data collection module 30 of the bridge device 16 reads the transmitted signals on the first bus 14, in order to determine whether the present signals are related to the devices it is responsible for. If there are signals related to the devices that the data collection module 30 is responsible for, the data must be collected for further processing. Therefore, when the data collection module 30 determines that the address signals currently on the first bus 14 points to the peripheral devices 18, the entire set of control signals on the first bus 14 is collected to the bus protocol transfer module 32, so as to transfer from the first bus protocol to the second bus protocol. The second bus protocol then transfers the set of control instructions to the peripheral device 18. These signals are illustrated in the lower half of FIG. 3. The bridge device 16 transfers the set of control instructions to the peripheral device 18 by the method of time-sharing. Specifically, the bridge device 16 first transfers the address signals that are in accord with the second bus protocol to the peripheral device 18 with a latch-address signal. Then, the bridge device 16 transfers the data signal to the peripheral device 18 with a write signal. Thus, the processor 12 uses the first bus 14, the bridge device 18, and the second bus 20 to successfully write data into the peripheral device 18, and it does not have to go through a micro-controller in the peripheral devices to complete the above task as in the prior art. The signal waveform of the second bus is shown in FIG. 3. The control signals of the second bus mainly include an address signal, a data signal, a write signal, a read signal (not shown), and a latch-address signal. The signals produced on the second bus are usually in a specific waveform, like the format of asynchronous control signal, so as to transmit data or produce signals to control the peripheral device 18, where the operating clock rate is usually several MHz to 30 MHz.

In this embodiment, the peripheral device 18 may be one of the peripheral devices of the MSC-51 series, for example, a peripheral device of MSC-51 8032. In addition, the peripheral device 18 may also be an optical disc drive, a recordable optical disc drive, a USB transceiver, a GPIO controller, or any other peripheral devices independent from the IC incorporating the processor 12. The commonality of the peripheral devices is that they usually only passively accept control instructions from other components. The processor 12 may be a computer system that couples to the peripheral devices or the Central Processing Unit (CPU) of the computer system that is sending out the instructions. Moreover, so long as the peripheral device 18 can accept control from external micro-controller, e.g. from an external micro-controller of the MSC 51 series, the interior of peripheral device 18 does not need to comprise the micro-controller, or it may comprise a micro-controller, but it does not need to utilize the micro-controller to process the controlling action on peripheral device as disclosed in the embodiment.

The peripheral device discussed in this embodiment does not need to incorporate a controller, but it can accept the control instructions from the computer system it couples to. A control instruction will correspond to a series of continuous specific waveforms; the bridge device 16 is used for transforming the control instructions that corresponds with the specific waveforms, in order to replace the role of the micro-controller in the prior art. Without the bridge device 16, the processor 12, generally with high speed, will be relied on to produce this kind of waveforms. Thus, the processor 12 must reserve some system resource for this task, and it will influence the overall efficiency of the control system 10. In the peripheral device of the MSC-51 series in this embodiment, if it has a micro-controller therein, the micro-controller is usually with slow speed (<30 MHz) and has less bus width (8 or 16 bits), but it must be able to accept the instruction from the high-speed processor 12.

In this embodiment, the processor 12 could directly transmit instructions to the peripheral device 18 through the first bus 14 and the bridge device 16, in order to control the operations of the peripheral device 18. For example, the processor 12 could directly transmit instructions to respectively command the pickup head of the optical disc drive to move to a specific position, the pivot motor to rotate, and the laser head to read the data. Because the processor 12 could directly control the peripheral device 18, the peripheral device 18 being controlled does not need to incorporate a micro-controller, so long as it could distinguish and accept instructions from the micro-controller. Thus, this can reduce the manufacturing cost of the peripheral device.

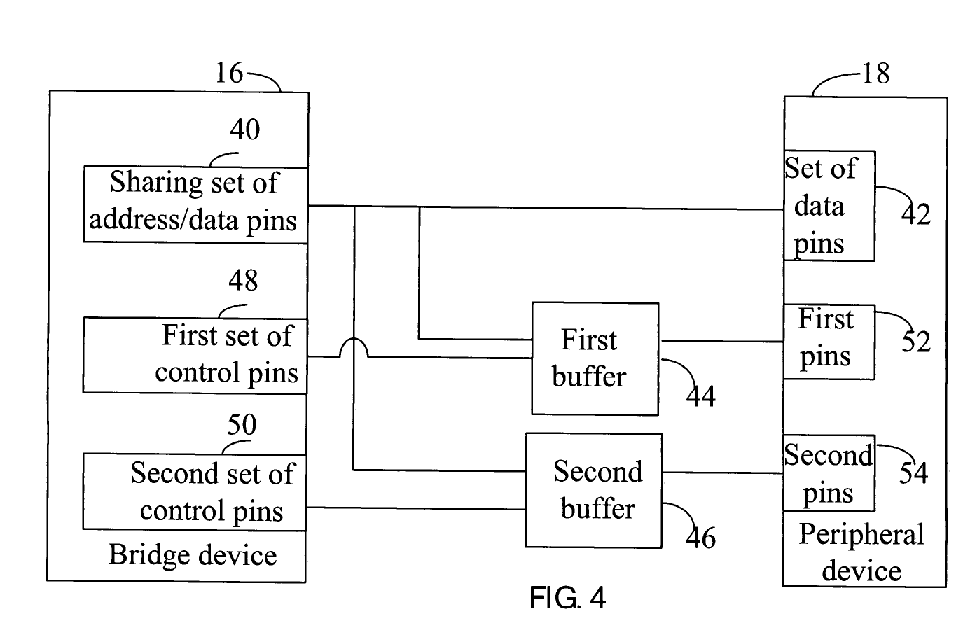

FIG. 4 is the function block diagram of the peripheral device 18 and the bridge device 16 of FIG. 1. The peripheral device 18 may utilize the method sharing pins to couple to the bridge device 16. The bridge device 16 comprises a shared set of address/data pins 40. The shared address/data pins 40 simultaneously couple to a set of data pins 42 of the peripheral device 18, with a first buffer 44, and with a second buffer 46. The buffers 44, 46 may be registers. In addition, the bridge device 16 comprises a first set of control pins 48 and a second set of control pins 50 that respectively couples to the first buffer 44 and the second buffer 46. The peripheral device 18 comprises a first set of pins 52 and a second set of pins 54 that respectively couple to the first buffer 44 and the second buffer 46. The first set of pins 52 could be higher address pins of the peripheral device 18, and the second set of pins 54 can be lower address pins of the peripheral device 18. The shared set of address/data pins 40 of the bridge device 16 respectively transmit a first signal, a second signal, and a data signal to the first buffer 44, the second buffer 46, and the set of data pins 42 of the peripheral device 18. This first buffer 44 stores the first signals temporarily, and the second buffer 46 stores the second signal temporarily. Afterwards, the first set of control pins 48 and the second set of control pins 50 of the bridge device 16 respectively transmit control signals to control the first buffer 44 and the second buffer 46, so as to transmit the first signal and the second signal to the first set of pins 52 and the second set of pins 54 of the peripheral device 18. By utilizing the first buffer 44, the first set of control pins 48 of the bridge device 16 could allow, by time-sharing of the set of data pins 42 of the peripheral device 18 and the first pins 52, to share the sharing set of address/data pins 40 of the bridge device 16. Similarly, by utilizing the second buffer 46, the second set of control pins 50 of the peripheral device 16 could allow the set of data pins 42 and the second set of pins 54 of the peripheral device 18 to share the sharing set of address/data pins 40 of the bridge device 16.

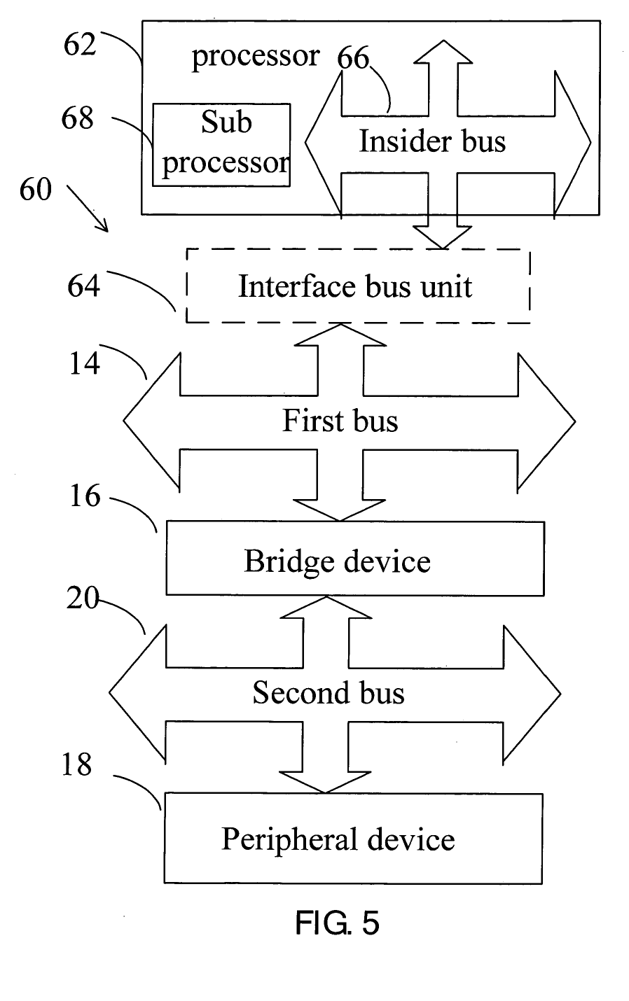

The invention may also be applied to a control system where the processor 12 does not use the AMBA bus. FIG. 5 is a function block diagram of another embodiment of the control system of the invention. In the control system 60, the processor 62 comprises a sub-processor 68 and an internal bus 66. That is to say, the processor 62 does not use AMBA bus; instead, it uses its own specific internal bus 66. The specific internal bus 66 will be referred to as a third bus hereinafter. In this case, instructions can first be passed through the interface bus unit 64 to undergo the operation of bus transfer; the signals of the internal bus (or the third bus) of the processor 62 are first transformed into signals with the format of the first bus 14 (AMBA bus), and the rest of the transmission of signals of the bridge device 16 and peripheral device 18 is the same as the first embodiment, so the details would not be described again. Thus, even if the signals of the processor 62 use its own specific internal bus 66, it can also use this invention. According to the above, the characteristics and advantages of the control system of the embodiments include:

1. This embodiment uses the processor in cooperation with the bridge device to directly control the peripheral device, and it does not need the micro-controller inside the peripheral devices to control the operations of a peripheral device. The peripheral devices are mainly controlled by the bridge device through the second bus. Under this kind of condition, it is not important whether the peripheral control device comprises a micro-controller, so long as the second bus can exert its control; the micro controller within the peripheral device could even be omitted, so this invention can save the manufacturing cost of the micro-controller while normal operations could still be performed.

2. The bridge device of the embodiment could transform the control instructions transmitted by the processor into specific waveforms, so that the specific waveforms could be used to control various operations of the peripheral device. Therefore, the bridge device replaces the role of the micro-controller in the prior art. In general, the internal circuit of the micro-controller is much more complicated than the bridge device of the embodiment, thus omitting the micro-controller and being able to achieve the purpose of controlling peripheral devices with the bridge device of the could save manufacturing cost.

3. In addition to cost consideration, without the bridge device of the embodiment, the conventional processor of control system must generate the waveform of the controlling of the peripheral device. Thus, the processor must reserve some system resource to perform this task. This will affect the overall efficiency of the control system. The bridge device could share a great deal of the loading of the processor in controlling the peripheral devices. Therefore, it allows the processor to work more efficiently. Thus, the overall efficiency of the control system is improved.

4. The invention may also be applied to where the processor does not use the AMBA bus. In this case, the internal bus signal of the processor is first transformed into a signal with the format of the AMBA bus by the bus transforming technology of the prior art. Then, it could adopt this stated technology in the embodiment of the control system.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

1. A system for controlling a peripheral device, the system comprising:
a processor generating a set of control instructions;
a first bus coupling to the processor and transmitting the set of control instructions according to a first bus protocol; and
a bridge device communicating with the processor through the first bus according to the first bus protocol and communicating with the peripheral device through a second bus according to a second bus protocol;
whereas the processor transmitting the set of control instructions from the first bus, the bridge device, and the second bus to the peripheral device, and directly controlling the peripheral device to perform an operation.

2. The system of claim 1, wherein the bridge device comprising:
a data collection module, selectively receiving the set of control instructions through the first bus; and
a bus protocol transfer module coupled to the data collection module, the bus protocol transfer module receiving the set of control instructions and transmitting the set of control instructions to the peripheral device through the second bus.

3. The system of claim 1, wherein the set of control instructions comprising:
an address signal, a latch-address signal, a write signal, a data signal, and a data confirming signal.

4. The system of claim 1, wherein the peripheral device does not comprise a microcontroller.

5. The system of claim 1, wherein the peripheral device comprises a microcontroller.

6. The system of claim 5, wherein the microcontroller is one of the MSC 51 family controllers.

7. The system of claim 1, wherein the processor is a reduced instruction set computer processor.

8. The system of claim 1, wherein the first bus is an advanced microcontroller bus architecture bus.

9. The system of claim 1, wherein the processor comprising:
a sub-processor;
a third bus coupled to the sub processor according to a third bus protocol; and
the third bus of the processor coupled to an interface bus unit through the first bus.

10. The system of claim 9, wherein the sub-processor transmitting the set of control signals from the third bus to the interface bus unit according to the third bus protocol, and the interface bus unit transmitting the set of control instructions from the first bus to the bridge device according to the first bus protocol.

11. The system of claim 10, wherein the first bus is the advanced microcontroller bus architecture bus, the third bus being an internal bus, and the sub processor being the reduced instruction set computer processor.

12. A computer system, the computer system comprising:
a peripheral device;
a processor generating a set of control instructions;
a first bus coupling to the processor and transmitting the set of control instructions to the first bus; and
a bridge device communicating with the processor to the first bus according to the first bus protocol and communicating with a peripheral device to the second bus according to a second bus protocol; whereas the processor transmitting a set of control instructions from the first bus, the bridge device, and the second bus to the peripheral device, and directly controlling the peripheral device to perform an operation.

13. The computer system of claim 12, wherein a sharing set of address/data pins of the bridge device couples a set of data pins of the peripheral device, the sharing set of address/data pins coupling to a first buffer, the first buffer further coupling to a first set of pins of the peripheral device, the first set of control pins coupling to the first buffer, the sharing set of address/data pins of the bridge device sharing the set of data pins and the first set of pins at sharing time.

14. The computer system of claim 13, wherein the sharing set of address/data pins of the bridge device couples to a second buffer, the second buffer further coupling to a second set of pins of the peripheral device, the second set of control pins of the bridge device coupling to the second buffer, the sharing set of address/data pins of the bridge device sharing the set of data pins, the first set of pins, and the second set of pins at sharing time.
